(19) United States
(12) Patent Application Publication
(10) Pub. No.: US 2026/0236092 A1
(43) Pub. Date: Aug. 13, 2026

(54) CALIBRATING GAZE TRACKING BASED ON HEAD MOVEMENT

(71) Applicant: GOOGLE LLC, Mountain View, CA (US)

(72) Inventors: Jason Todd Spencer, Rocklin, CA (US); Qinge Wu, Fremont, CA (US); Jim Marggraff, Incline Village, NV (US); Pohung Chen, Tokyo (JP)

(21) Appl. No.: 19/154,311

(22) PCT Filed: Feb. 10, 2023
(86) PCT No.: PCT/US2023/062387

§ 371 Date: Aug. 6, 2025

(51) Int. Cl. G06F 3/01; G02B 27/01; G06F 1/16; G06F 3/04842

(52) U.S. Cl. CPC G06F 3/013; G02B 27/0179; G06F 1/163; G06F 3/012; G02B 2027/0187; G06F 3/04842

(57) ABSTRACT

A head-mounted device may identify a first location based on a first direction of a gaze of at least one eye of a user, the head-mounted computing device being mounted on a head of the user. The head-mounted device may identify a second location in response to a movement of the head of the user. The head-mounted device may receive, from the user, a selection associated with the second location. The head-mounted device may generate a calibration adjustment based on the first direction, the second location, and the selection. The head-mounted device may identify a third location based on a second direction of the gaze of the at least one eye of the user and the calibration adjustment.

### TECHNICAL FIELD

This description relates to head-mounted devices that display a user interface.

### BACKGROUND

Head-mounted devices can create a user interface within a virtual reality environment by presenting a selectable icon. The user can control a cursor by moving the user's eyes, and the head-mounted device can track a direction of the gaze of the user's eyes. However, the tracking of the direction of the gaze can be inaccurate.

### SUMMARY

When a user believes that the user is looking at (e.g., gazing at) an icon that the user would like to select, but the head-mounted device displays the cursor at a location other than the location of the icon, the user can move the user's head, causing the head-mounted device to move. The user can move the user's head as a reaction to the cursor being at a location other than expected and can move their head in an attempt to move the cursor to the desired location of the icon. The head-mounted device can respond to the movement by moving the cursor. When the cursor is at a location where the user would like to make a selection, the user can make the selection. The head-mounted device can generate a calibration adjustment based on the head movement and the selection, improving the accuracy of future placements of the cursor based on the direction of the gaze of the user's eye. In other words, according to the implementations described herein, the head-mounted device can recalibrate to improve the accuracy of tracking the eye gaze.

In some aspects, the techniques described herein relate to a method performed by a head-mounted computing device, the method including: identifying a first location based on a first direction of a gaze of at least one eye of a user, the head-mounted computing device being mounted on a head of the user; identifying a second location in response to a movement of the head of the user; receiving, from the user, a selection associated with the second location; generating a calibration adjustment based on the first direction, the second location, and the selection; and identifying a third location based on: a second direction of the gaze of the at least one eye of the user; and the calibration adjustment.

In some aspects, a non-transitory computer-readable storage medium can include instructions stored thereon. When executed by at least one processor, the instructions can cause a head-mounted computing device to identify a first location based on a first direction of a gaze of at least one eye of a user, the head-mounted computing device being mounted on a head of the user; identify a second location in response to a movement of the head of the user; receive, from the user, a selection associated with the second location; generate a calibration adjustment based on the first direction, the second location, and the selection; and identify a third location based on a second direction of the gaze of the at least one eye of the user; and the calibration adjustment.

In some aspects, a computing device configured to mount onto a head of a user comprises a display, a gaze-tracking camera, at least one processor and a non-transitory computer-readable storage medium including instructions stored thereon. When executed by the at least one processor, the instructions can cause the computing device to identify a first location based on a first direction of a gaze of at least one eye of the user, the computing device being mounted on the head of the user; identify a second location in response to a movement of the head of the user; receive, from the user, a selection associated with the second location; generate a calibration adjustment based on the first direction, the second location, and the selection; and identify a third location based on a second direction of the gaze of the at least one eye of the user; and the calibration adjustment.

In some aspects, the techniques described herein relate to a method performed by a head-mounted device, the method including: identifying a first location on a display based on a direction of a gaze of a user wearing the head-mounted device, the display being included in the head-mounted device; determining, based on the direction of the gaze of the user remaining fixed for a predetermined period of time, that the first location was inaccurate; and identifying a second location on the display based on the direction of the gaze and movement of the head-mounted device.

In some aspects, a non-transitory computer-readable storage medium can include instructions stored thereon. When executed by at least one processor, the instructions can cause a head-mounted computing device to identify a first location on a display based on a direction of a gaze of a user wearing the head-mounted device, the display being included in the head-mounted device; determine, based on the direction of the gaze of the user remaining fixed for a predetermined period of time, that the first location was inaccurate; and identify a second location on the display based on the direction of the gaze and movement of the head-mounted device.

In some aspects, a computing device configured to mount onto a head of a user comprises a display, a gaze-tracking camera, at least one processor and a non-transitory computer-readable storage medium including instructions stored thereon. When executed by the at least one processor, the instructions can cause the computing device to identify a first location on the display based on a direction of a gaze of the user wearing the computing device, the display being included in the head-mounted device; determine, based on the direction of the gaze of the user remaining fixed for a predetermined period of time, that the first location was inaccurate; and identify a second location on the display based on the direction of the gaze and movement of the computing device.

In some aspects, the techniques described herein relate to a method performed by a head-mounted computing device, the method including: displaying a cursor at a first location, the first location of the cursor being based on a first direction of a gaze of at least one eye of a user, the head-mounted computing device being mounted on a head of the user; moving the cursor to a second location in response to a movement of the head of the user; receiving, from the user, a selection associated with the second location; generating a calibration adjustment based on the first direction, the second location, and the selection; and displaying the cursor at a third location, the third location of the cursor being based on a second direction of the gaze of the at least one eye of the user and the calibration adjustment.

In some aspects, a non-transitory computer-readable storage medium can include instructions stored thereon. When executed by at least one processor, the instructions can cause a head-mounted computing device to display a cursor at a first location, the first location of the cursor being based on a first direction of a gaze of at least one eye of a user, the head-mounted computing device being mounted on a head of the user; move the cursor to a second location in response to a movement of the head of the user; receive, from the user, a selection associated with the second location; generate a calibration adjustment based on the first direction, the second location, and the selection; and display the cursor at a third location, the third location of the cursor being based on a second direction of the gaze of the at least one eye of the user, and the calibration adjustment.

In some aspects, a computing device configured to mount onto a head of a user comprises a display, a gaze-tracking camera, at least one processor and a non-transitory computer-readable storage medium including instructions stored thereon. When executed by at least one processor, the instructions can cause the computing device to display a cursor at a first location, the first location of the cursor being based on a first direction of a gaze of at least one eye of the user, the head-mounted computing device being mounted on the head of the user; move the cursor to a second location in response to a movement of the head of the user; receive, from the user, a selection associated with the second location; generate a calibration adjustment based on the first direction, the second location, and the selection; and display the cursor at a third location, the third location of the cursor being based on a second direction of the gaze of the at least one eye of the user, and the calibration adjustment.

The details of one or more implementations are set forth in the accompanying drawings and the description below. Other features will be apparent from the description and drawings, and from the claims.

### BRIEF DESCRIPTION OF THE DRAWINGS

FIG. 1A shows a user in a physical space wearing a head-mounted device and an image seen by the user.

FIG. 1B shows the head-mounted device tracking a gaze of the user.

FIG. 1C shows an image seen by the user, including an icon and a cursor.

FIG. 1D shows the user moving the user's head, which causes movement of the head-mounted device.

FIG. 1E shows movement of the cursor in response to the movement of the head-mounted device.

FIG. 1F shows movement of the cursor onto the icon in response to the movement of the head-mounted device.

FIG. 1G shows selection of the icon.

FIG. 1H shows a direction and magnitude of calibration adjustment.

FIG. 1I shows placement of the cursor on a second icon based on a direction of the gaze of the user's eye and the calibration adjustment.

FIG. 2 is a flowchart showing a method performed by the head-mounted device.

FIG. 3 is a block diagram of the head-mounted device.

FIGS. 4A, 4B, 4C show an example of the head-mounted device.

FIG. 5 is a flowchart showing a method performed by the head-mounted device according to an example.

FIG. 6 is a flowchart showing a method performed by the head-mounted device according to an example.

FIG. 7 is a flowchart showing a method performed by the head-mounted device according to an example.

Like reference numbers refer to like elements.

### DETAILED DESCRIPTION

A head-mounted device, which can also be considered a head-mounted computing device, smartglasses, and/or augmented reality (AR) glasses, can create an augmented reality (AR) environment virtual reality (VR) environment, extended reality (XR), and/or mixed reality (MR) environment for a user who is wearing the head-mounted device. The head-mounted device can either include transparent lenses through which the user sees the physical scene in front of the user, or can include a display that displays the physical scene in front of the user, and can add virtual objects to the lenses and/or display.

The virtual objects generated by the head-mounted device can include one or more computer-generated icons (also can be referred to as a computer-generated virtual element or as a computer-generated virtual object) that can form, and/or be included in, a user interface. The user can select one or more of the computer-generated icons, prompting a response from the head-mounted device. The response can include actions associated with the selected computer-generated icon such as, for example, launching an application, presenting search results, or presenting a menu with additional options.

The user can select a computer-generated icon, such as with a cursor (which can also be referred to as a selection indicator) or based on a gaze of the user. The user can select the computer-generated icons, prompting a response from the head-mounted device, with the cursor or by gazing at the computer-generated icon. Selecting the computer-generated icon can include placing the cursor on and/or over the computer-generated icon, or by looking at the computer-generated icon.

The user can control and/or place the cursor using at least one of the user's eyes. In some examples, the head-mounted device can include at least one gaze-tracking camera. The at least one gaze-tracking camera can determine a direction of a gaze of at least one of the eyes of the user. Based on the direction of the gaze determined by the gaze-tracking camera, the head-mounted device can determine a location on the display and/or lens that the user is looking at. In some examples, the head-mounted device can generate and/or place the cursor at the determined location (the determined location can also be considered an identified location). In some examples, the head-mounted device can process a selection of a computer-generated icon at the determined location. In some examples, the processing of the selection of the computer-generated icon can include the head-mounted device changing an appearance of the computer-generated icon, such as by highlighting the computer-generated icon, changing a color of the computer-generated icon, and/or changing a size of the computer-generated icon. The change of the appearance of the computer-generated icon by the head-mounted device can indicate that the computer-generated icon was selected by the user.

In some instances, the determined and/or identified location can be a location different than the location at which the user intends to place the cursor and/or make a selection (such as selecting a computer-generated icon). Errors in determining the location can be caused by variance in placement of the head-mounted device on the head of the user, variance in the location of the user's eyes with respect to the user's ears and/or nose (on which the head-mounted device is disposed), or triangulation effects, as non-limiting examples. In some examples, the head-mounted device can determine that the location at which the head-mounted device generated and/or placed the cursor was inaccurate. The head-mounted device can determine that the location at which the head-mounted device generated and/or placed the cursor, and/or processed a selection, was inaccurate based, for example, on the user continuing to look at the same location without performing a selection action or based on head movement of the user.

In response to determining that the location at which the head-mounted device generated and/or placed the cursor was inaccurate (which can be a technical problem), the head-mounted device can move the cursor and/or change the identified location. The head-mounted device can move the cursor and/or change the identified location based on head-movement of the user and/or detected movement of the head-mounted device. The head-mounted device can, for example, move the cursor in an initial direction of movement of the head of the user and/or of the head-mounted device.

After the head-mounted device has moved the cursor and/or changed the identified location in response to movement of the head of the user and/or of the head-mounted device, the cursor may be located on and/or in the location of a computer-generated icon that the user desires to select. In some implementations, the user can continue moving the head of the user until the head-mounted device moves the cursor onto and/or to the location of the computer-generated icon that the user desires to select. When the user selects the computer-generated icon, the head-mounted device can perform an action associated with the computer-generated icon.

The head-mounted device can also generate and/or change a calibration adjustment, which can be at least one technical solution to the technical problems described above. The calibration adjustment is a parameter that the head-mounted device considers, in conjunction the direction of the gaze, in determining where to place and/or generate the cursor. In an example, the calibration adjustment can be based on a location at which the head-mounted device initially placed and/or generated the cursor before the movement of the head of the user and/or head-mounted device and the location of the cursor (and/or identified location) that was selected by the user. In an example, the calibration adjustment can be based on a displacement between the location at which the head-mounted device initially placed and/or generated the cursor before the movement of the head of the user and/or head-mounted device and the location of the cursor that was selected by the user. When the head-mounted device subsequently generates and/or locates a cursor, the head-mounted device can determine the location of the cursor based on the calibration adjustment as well as the determined direction of the gaze of at least one eye of the user.

The generation and/or change of the calibration adjustment has the technical benefit of improving the accuracy with which the head-mounted device locates the cursor. The calibration adjustment can improve the accuracy of locating the cursor for future placements of the cursor. The calibration adjustment has the technical benefit that future placements of the cursor can be accurate without any additional head movement.

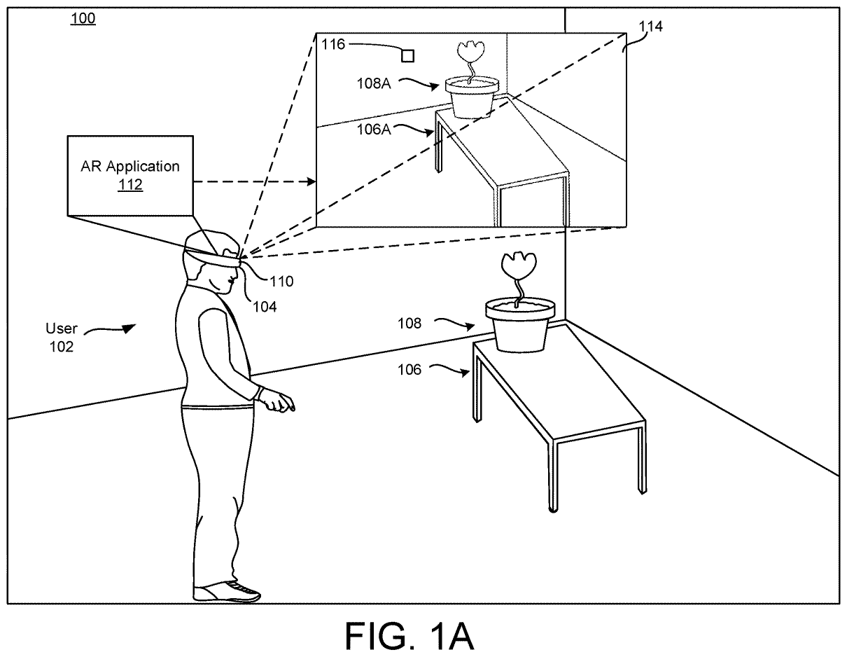

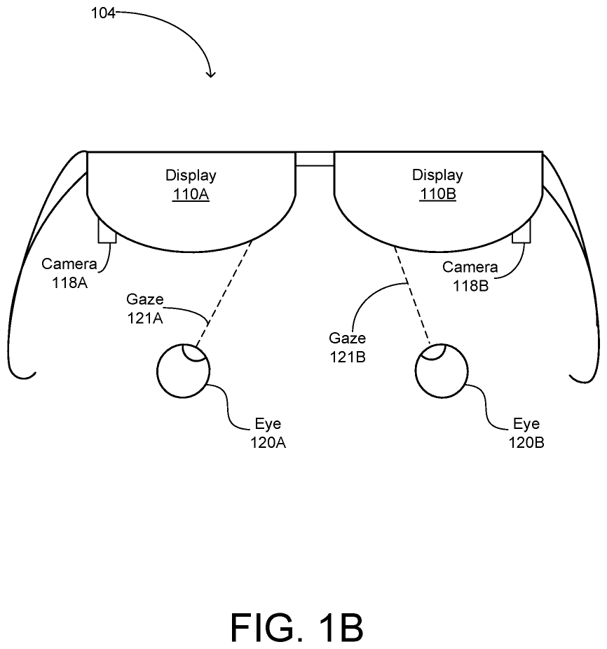

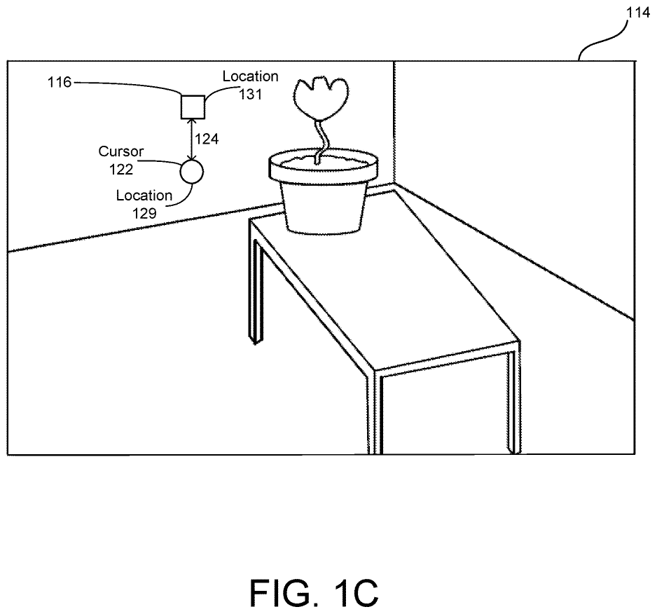

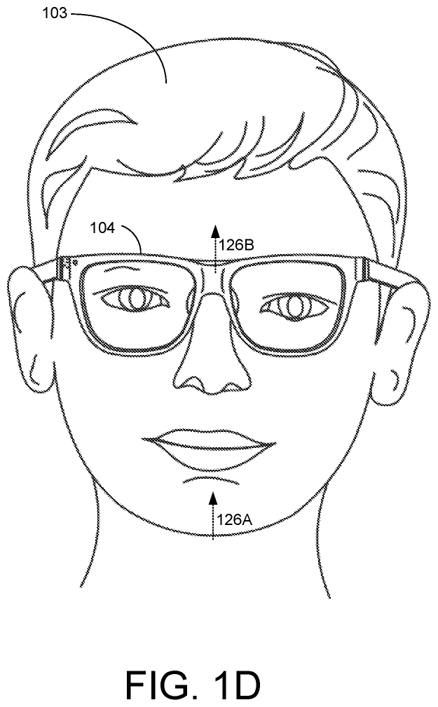

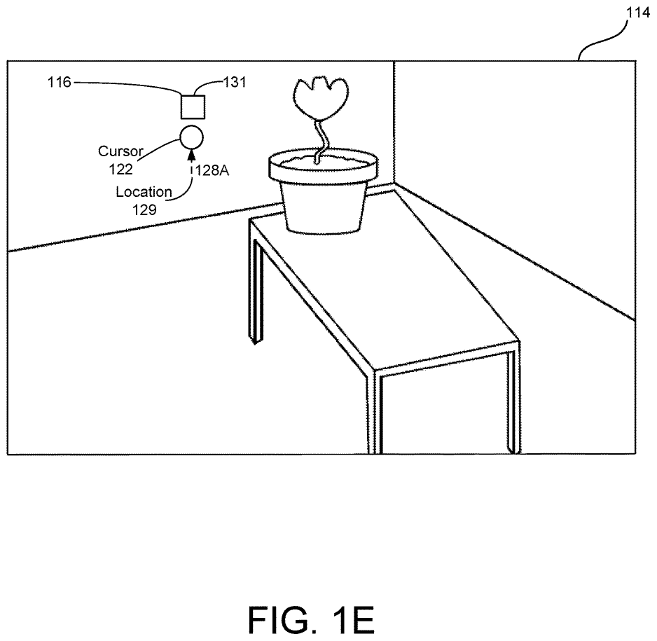

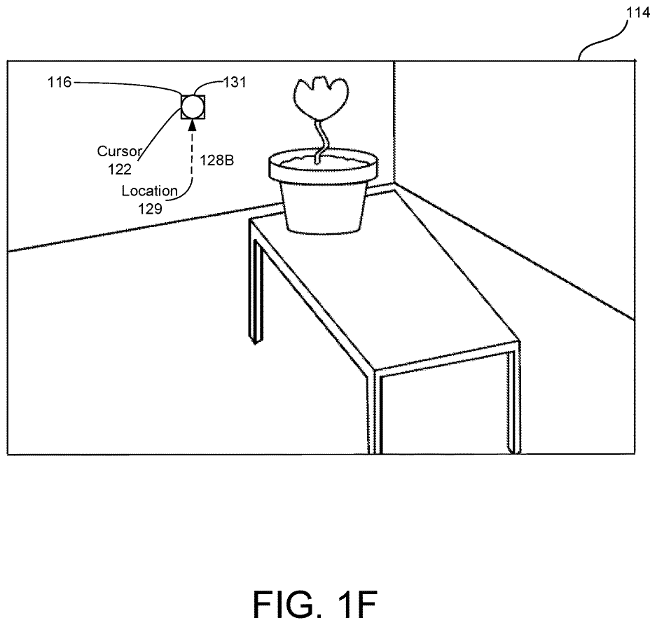

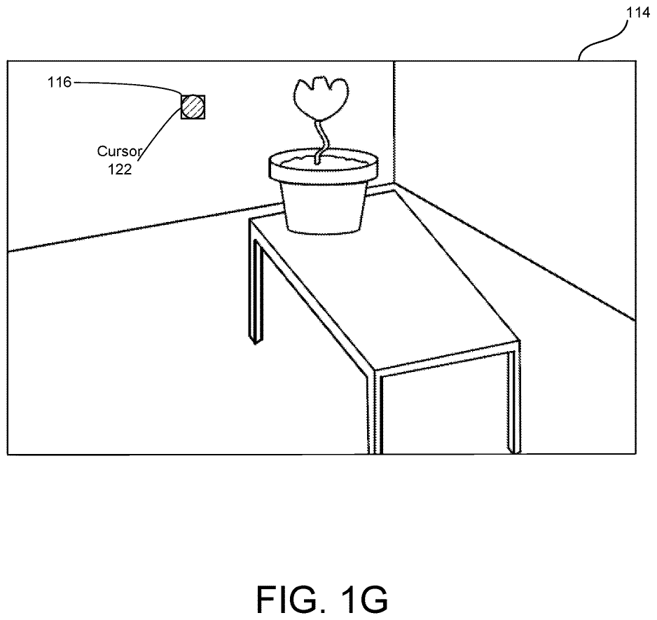

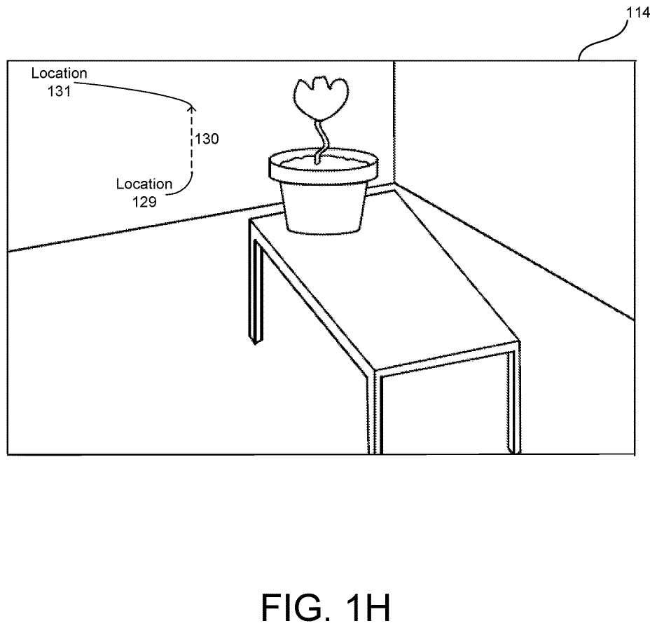

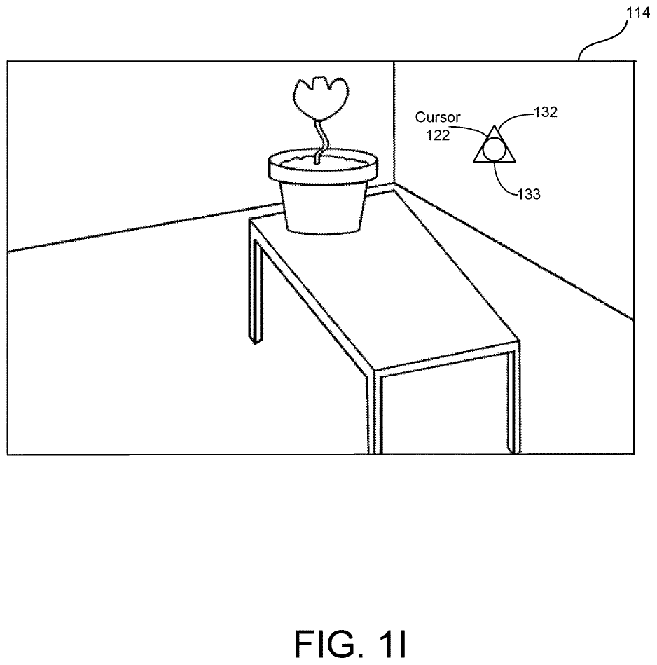

FIGS. 1A through 1I show a head-mounted device 104 interacting with a user 102 in an augmented reality environment. The head-mounted device 104 presents an icon 116 to the user 102 in the augmented reality environment, adjusts a location of a cursor 122 in response to head 103 movement of the user 102, and later accurately places the cursor 122 without additional head 103 movement. While the cursor 122 is shown and described with respect to FIGS. 1A through 1I, the cursor 122 can also represent an identified location. In some examples, no cursor is shown (e.g., displayed) in the display 110, 110A.

FIG. 1A shows a user 102 in a physical space 100 wearing a head-mounted device 104 and an image 114 seen by the user 102. In this example, the user 102 is experiencing an augmented reality environment through a display 110 included in the head-mounted device 104. The augmented reality environment, which is created by the image 114, can be generated by an augmented reality application 112 executing on the head-mounted device 104 and displayed (e.g., displayed on the inner side of the lenses) to the user 102 through the head-mounted device 104, or other device. The image 114 and/or augmented reality environment includes at least one inserted augmented object (e.g., content), such as a computer-generated icon 116, that is displayed over an image of the physical space 100 (which can be displayed within the display 110 using a pass-through (e.g., outward facing) camera attached to the head-mounted device 104 or by transparent lenses onto which the augmented object is projected). The computer-generated icon 116 can also be considered a key. In this example, the computer-generated icon 116 (also can be referred to as a computer-generated virtual element or object) is represented as a square, selection of which can call a menu or search results, near a representation 106A of a table 106 and/or near a representation 108A of a flower 108 in the image 114. The image 114, as shown in FIG. 1A, does not actually appear in the physical space 100, but is displayed to the user 102 within the head-mounted device 104. In some examples, the computer-generated icon 116 can be translucent, allowing the user to see the physical objects and/or representations of physical objects behind the computer-generated icon 116.

FIG. 1B shows the head-mounted device 104 tracking a gaze 121A, 121B of the user 102. The head-mounted device 104 can include one or more gaze-tracking cameras 118A, 118B. While cameras 118A, 118B is used herein, the gaze-tracking cameras 118A, 118B can refer to any type of sensor that can determine a direction in which the eyes 120A, 120B are looking and/or pointing. The gaze-tracking camera(s) 118A, 118B can face toward an eye(s) 120A, 120B of the user 102 when the head-mounted device 104 is mounted on a head of the user 102.

The eye(s) 120A, 120B of the user 102 can face and/or look toward a display 110A, 110B included in the head-mounted device 104. The displays 110A, 110B can be components of the display 110 shown and described with respect to FIG. 1A. The display 110A, 110B can include electronic displays that generate images or transparent lenses. The camera(s) can capture images of the eye(s) 120A, 120B of the user 102, images of a retina(s) included in the eye(s) 120A, 120B, and/or images of a pupil(s) included in the eye(s) 120A, 120B. Based on the captured images of the eye(s) 120A, 120B, retina(s), and/or pupil(s) the gaze-tracking camera(s) 118A, 118B, and/or the head-mounted device 104, can determine a direction of a gaze 121A, 121B of the respective eye 120A, 120B.

FIG. 1C shows the image 114 seen by the user 102, including the icon 116 and a cursor 122 (e.g., selection indicator). The image 114 is the image 114 shown in FIG. 1A as generated by the AR application 112.

In this example, the head-mounted device 104 has determined, based on the captured gaze(s) 121A, 121B of the user 102, that the user 102 is looking at a first location 129 where the cursor 122 is shown in FIG. 1C. Based on the determination that the user 102 is looking at the first location 129, the head-mounted device 104 generated the cursor 122 at the first location 129.

In some examples, the head-mounted device 104 does not generate a cursor 122. In examples in which the head-mounted device 104 does not generate a cursor 122, the head-mounted device 104 can process selection of an icon at the location at which the head-mounted device 104 determines that the user 102 is looking, such as the first location 129. The location at which the head-mounted device 104 determines that the user 102 is looking is based on (e.g., is directly from) the direction(s) of the gaze(s) 121A, 121B of the user 102. The head-mounted device 104 can determine the direction(s) of the gaze(s) 121A, 121B of the user 102 based on data captured by one or more sensors included in the head-mounted device 104, such as the gaze-tracking camera(s) 118A, 118B. If no computer-generated icon is present at the determined location, such as the first location 129, then the head-mounted device 104 may not process a selection. If a different computer-generated icon is present at the determined location, such as the first location 129, then the head-mounted device 104 may process a selection of the wrong computer-generated icon. The user 102 may indicate disapproval of the processing of the selection of the wrong computer-generated icon, such as by selecting a “back” or home button or computer-generated icon. The head-mounted device 104 can determine that the determined location was incorrect based on the indicated disapproval of the processing of the selection of the wrong computer-generated icon.

However, the user 102 was intending to look at (e.g., targeting using an eye gaze) a second location 131 where the computer-generated icon 116 is displayed and/or presented. Thus, while the user 102 intended to direct the gaze 121A, 121B of the user 102 toward the second location 131 of the computer-generated icon 116, the head-mounted device 104 presented the cursor 122 at a first location 129 that is a displacement 124 distance and direction away from the location second 131 where the computer-generated icon 116 is displayed.

To correct the inaccurate location of the cursor 122 at the first location 129, the user 102 can move the head of the user 102, which also causes the head-mounted device 104 to move. The head-mounted device 104 can move and calibrate the cursor 122 based on the movement of the head of the user 102 and/or the movement of the head-mounted device 104.

In some examples in which the display 110 of the head-mounted device 104 does not present a cursor, the head-mounted device 104 can determine that the identified location (such as the first location 129) is different than the location that the user was intending to look at (such as the second location 131) based on detecting the user 102 looking at a same location and/or the gaze(s) 121A, 121B remaining constant and/or fixed for a predetermined time duration such as a fixated time threshold and the user 102 not activating a selection and/or the head-mounted device 104 not receiving a selection from the user 102.

In some examples, the head-mounted device 104 generates the cursor 122 upon entering a correction mode and/or head-enabled correction mode based on determining that the user was intending to look at a location other than the first location 129. During the correction mode, a location of the cursor 122 can be fixed on the display 110, 110A, whereas the computer-generated icon 116 remains fixed with respect to objects in the physical space 100, and move within the display 110, 110A when the head-mounted device 104 and/or display 110, 110A moves.

FIG. 1D shows the user 102 moving the user's 102 head 103, which causes movement of the head-mounted device 104. In this example, the initial movement of the user's 102 head 103 and the head-mounted device 104 is up. The upward movement 126A of the user's 102 head 103 is shown by an arrow extending up from the user's 102 chin. The upward movement 126B of the head-mounted device 104 is shown by an arrow extending up from a bridge of the head-mounted device 104.

In some examples, the head-mounted device 104 can move the cursor 122 (not shown in FIG. 1D) in response to the initial movement and/or acceleration, and ignore movement in the opposite direction when the user 102 moves the user's 102 head 103 in the opposite direction to return the head 103 to the original position before the movement 126A. The head-mounted device 104 can move the cursor 122 in a direction of the movement 126A, 126B of the head 103 and/or head-mounted device 104.

FIG. 1E shows movement 128A of the cursor 122 in response to the movement 126B of the head-mounted device 104. The cursor 122 has moved part of the way from the first location 129, where the head-mounted device 104 determined that the user 102 was looking, toward the second location 131, where the computer-generated icon 116 is located and where the user 102 intended to look.

FIG. 1F shows movement 128B of the cursor 122 onto the icon 116 in response to the movement 126B of the head-mounted device 104. In FIG. 1F, the head-mounted device 104 has moved the cursor 122 all the way from the first location 129, where the head-mounted device 104 determined that the user 102 was looking, toward the second location 131, where the computer-generated icon 116 is located and where the user 102 intended to look. The direction of movement 128A, 128B from the first location 129 to the second location 131 can be considered and adjustment direction.

FIG. 1G shows selection of the icon 116. The selection of the icon 116 is shown in FIG. 1G by the shading of the icon 116 and/or cursor 122. The user 102 has selected the icon 116. The user 102 may have selected the icon 116 by performing a predetermined head movement (such as moving the head 103 in an opposite direction, or in an orthogonal direction, from a direction that the user's 102 eye(s) 120A, 120B moved), by blinking, by tapping on the head-mounted device 104, or providing input to a keyboard, mouse, or touchpad that is in communication with the head-mounted device 104, as non-limiting examples.

In some examples, an appearance of the computer-generated icon 116 can change in response to a distance of the cursor 122 from the computer-generated icon 116 satisfying a distance threshold. The distance threshold can be satisfied when the cursor 122 is on or near the computer-generated icon 116. The change of appearance can include highlighting or shading, as shown in FIG. 1G. The change in appearance can indicate to the user 102 that the user 102 can select the computer-generated icon 116. In some examples, the change in appearance can include a prompt, such as a directional arrow and/or text indicating a direction that the user 102 should move the head 103 of the user 102 to select the computer-generated icon 116 and prompt the head-mounted device 104 to perform the action.

FIG. 1H shows a direction and magnitude of calibration adjustment 130. The head-mounted device 104 can determine the calibration adjustment 130 as a direction and magnitude of the displacement of the second location 131, where the user 102 intended to look, and the first location 129, where the head-mounted device 104 determined that the user was gazing. The head-mounted device 104 can determine the calibration adjustment 130 based on a first direction of the user's gaze 121A, 121B, the movement 126A, 126B of the head 103 and/or head-mounted device 104, the second location 131, and/or the selection of the computer-generated icon 116.

After determining and/or generating the calibration adjustment 130, the head-mounted device 104 can consider the calibration adjustment 130 as a parameter when determining future locations of the cursor 122. The head-mounted device 104 can display the cursor 122 at a third location based on a second direction of the gaze 121A, 121B and the calibration adjustment 130.

FIG. 1I shows placement of the cursor 122 on a second icon 132 based on a direction of the gaze 121A, 121B of the user's eye(s) 120A, 120B and the calibration adjustment 130. The computer-generated icon 132 can have similar features as the computer-generated icon 116. In this example, the head-mounted device 104 has generated and/or placed the cursor 122 at a third location 133 based on the determined direction of the gaze 121A, 121B of the user's eye(s) 120A, 120B and the calibration adjustment 130. The head-mounted device 104 has accurately determined that the user 102 intended to place the cursor 122 on, and/or to look at, the computer-generated icon 132.

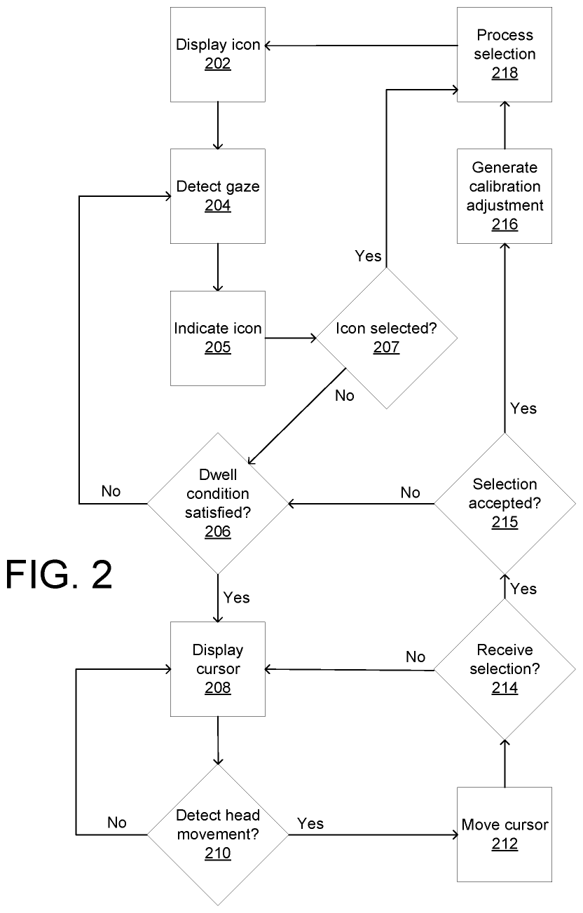

FIG. 2 is a flowchart showing a method performed by the head-mounted device 104. The head-mounted device 104 can display the computer-generated icon 116 (202). The head-mounted device 104 can display the computer-generated icon 116 by generating and/or presenting the computer-generated icon 116 on the display 110. The head-mounted device 104 can generate and/or present the computer-generated icon 116 on the display 110 by activating pixels that form the computer-generated icon 116, or by projecting light onto the lenses (that form the display 110A, 110B) to generate the computer-generated icon 116.

The head-mounted device 104 can detect the gaze(s) 121A, 121B of the user 102 (204). The computer-generated icon 116 can detect the gaze(s) 121A, 121B by capturing images of the eye(s) 120A, 120B of the user 102 with one or more gaze-tracking camera(s) 118A, 118B. Detecting the gaze(s) 121A, 121B of the user 102 (204) can include determining a location on the display 110 that the user 102 is looking at. Detecting the gaze(s) 121A, 121B of the user 102 (204) can include determining a duration, and/or length of time, that the user 102 is looking at the determined location on the display 110.

After and/or while detecting the gaze(s) 121A, 121B of the user 102 (204), the head-mounted device 104 can indicate an icon (205) toward which the head-mounted device 104 determines that the gaze(s) 121A, 121B is directed. The head-mounted device 104 can indicate an icon toward which the head-mounted device 104 determines that the gaze(s) 121A, 121B is directed by changing an appearance of the icon, such as by highlighting or shading the computer-generated icon 116 as described above with respect to FIG. 1G.

After and/or indicating the icon (205), the head-mounted device 104 can determine whether the icon was selected (207) by the user 102. The selection can include selection of a computer-generated icon 116, 132 that is indicated (205) such as by a change of appearance including highlighting or shading. The user 102 can select the indicated icon by clicking on the computer-generated icon 116, 132, for example. If the head-mounted device 104 receives a selection, such as clicking or head movement, then the head-mounted device 104 can determine that the indicated icon was selected. If the head-mounted device 104 does not receive a selection of the indicated icon, such as clicking or head movement, then the head-mounted device 104 can determine that the indicated icon was not selected.

If the head-mounted device 104 determines that the indicated icon was selected, then the head-mounted device 104 can process the selection (218) of the icon, as discussed below.

If the head-mounted device 104 determines that the indicated icon was not selected, then the head-mounted device 104 can determine whether a dwell condition is satisfied (206). The dwell condition can include a time during which the user 102 looks at a same place on the display 110, and/or the gaze(s) 121A, 121B is in a same direction, satisfying a gaze time threshold. The gaze time threshold can be a time duration, such as between half a second or a second (such as 800 milliseconds), after which the user 102 can be considered to be intending to interact with an object on the display 110. In some examples, the dwell condition can be considered to be satisfied if the direction of the gaze(s) 121A, 121B of the user 102 remains the same, and/or within gaze margin (such as five degrees), for a time that is greater than the gaze time threshold. In some examples, the dwell condition can be considered to be satisfied if the direction of the gaze(s) 121A, 121B of the user 102 remains the same, and/or within the gaze margin (such as five degrees), for a time that is at least the gaze time threshold.

If the dwell condition is not satisfied, then the head-mounted device 104 can continue detecting the gaze(s) 121A, 121B of the user 102 (204).

If the dwell condition is satisfied, then the head-mounted device 104 can display the cursor 122 (208). The head-mounted device 104 can display the cursor 122 (208) at a location on the display 110 based on the determined gaze(s) 121A, 121B of the user 102. The location on the display 110 where the head-mounted device 104 displays the cursor 122 can be a location where the head-mounted device 104 determines, based on the determined gaze(s) 121A, 121B of the user 102 and/or a calibration adjustment 130 associated with the user 102 (if the calibration adjustment has not been determined), that the user 102 intended to look and/or interact with one or more objects on the display 110.

In some examples, the head-mounted device 104 does not display a cursor 122. In examples in which the head-mounted device 104 does not display the cursor 122, the head-mounted device 104 can indicate icons 116, 132 toward which the gaze of the user 102 is directed, such as by changing the appearance of the icon 116, 132. In some examples, the head-mounted device 104 can indicate the icons 116, 132 toward which the gaze of the user 102 is directed while in the correction mode. In some examples, the head-mounted device 104 can generate the cursor 122 upon entering the correction mode. The cursor 122 can indicate where the head-mounted device 104 determined that the user 102 is looking and/or intending to interact. In some examples, the head-mounted device 104 does not generate a cursor 122 in the correction mode. In examples in which the head-mounted device 104 does not generate a cursor 122 in the correction mode, the head-mounted device 104 can still maintain a location at which the head-mounted device 104 determines that the user 102 is looking, and can modify an appearance of a computer-generated icon 116, 132 that is located where the head-mounted device 104 determines that the user 102 is looking and/or focusing. The head-mounted device 104 can determine the location at which the user 102 is looking and/or focusing based on a combination of the gaze(s) 121A, 121B and movement of the head 103 of the user 102.

While displaying the cursor 122, the head-mounted device 104 can determine whether the head-mounted device 104 detects movement of the head 103 of the user 102 (210). The head-mounted device 104 can detect movement of the head 103 based on accelerometer measurements performed by the head-mounted device 104. If the head-mounted device 104 does not detect movement of the head 103, then the head-mounted device 104 can continue displaying the cursor 122 (208) at the location that the head-mounted device 104 determines that the user 102 is intending to look.

If the head-mounted device 104 does detect head 103 movement, then the head-mounted device 104 can move the cursor 122 (212). The head-mounted device 104 can move the cursor 122 based on the head 103 movement. The head-mounted device 104 can, for example, move the cursor 122 in a direction corresponding to, and/or the same as, the initial movement of the head 103. In some examples, the magnitude of the movement of the cursor 122 can be based on a magnitude of movement and/or acceleration of the head 103.

In some examples, the determination of whether head movement is detected (210) (to be used for calibrating) can be based on whether the head-mounted device 104 detects movement of the head 103 and/or head-mounted device 104 multiple times and/or on multiple occasions. In some examples, the head-mounted device 104 can determine that movement (to be used for calibrating) occurred only if the head-mounted device 104 detects movement in the same direction a threshold number of times, such as two or three times, within a predetermined time span, such as within five seconds, while the display 110 is presenting a computer-generated icon 116. In some examples, the head-mounted device 104 can determine that movement (to be used for calibrating) occurred only if the head-mounted device 104 detects movement in the same direction a threshold number of times, such as two or three times, separated by a predetermined time span, such as at least five seconds apart, while the display 110 is presenting a computer-generated icon 116. Using multiple head movements to determine that the head movement is detected and/or that the movement is to be used for calibrating, in some implementations, can ensure that a single head movement was not caused by an event other than a desire by the user 102 to move the cursor 122.

After moving the cursor 122 (212), the head-mounted device 104 can determine whether the head-mounted device 104 received a selection (214) from the user 102. A selection can include a selection of a user interface element, such as the computer-generated icon 116. The head-mounted device 104 can determine that the head-mounted device 104 received a selection from the user 102 based on detecting a predetermined movement of the head-mounted device 104 caused by movement of the head 103 of the user 102, the user 102 touching and/or tapping on the head-mounted device 104 at a predetermined location, or detecting predetermined movements of the eye(s) 120A, 120B, as non-limiting examples. If the head-mounted device 104 determines that the head-mounted device 104 did not receive a selection from the user 102, and/or that the user 102 did not input a selection into the head-mounted device 104, then the head-mounted device 104 can continue displaying the cursor 122 (208) and/or presenting items such as a computer-generated icon 116 without presenting a cursor 122. In some examples, the head-mounted device 104 can determine whether the head-mounted device 104 received a selection (214) without first determining whether the head-mounted device 104 detects movement of the head 103 of the user 102 (210) and/or moving the cursor 122 (212).

If the head-mounted device 104 determines that the head-mounted device 104 did receive a selection from the user 102, then the head-mounted device 104 can determine whether the selection was accepted (215). The selection can include selection of a computer-generated icon 116, 132. The user 102 can accept the selection by activating the computer-generated icon 116, 132, such as by clicking on the computer-generated icon 116, 132 or otherwise activating the computer-generated icon 116, 132. If the head-mounted device 104 receives an acceptance of the selection, such as clicking or head movement, then the head-mounted device 104 can determine that the selection was accepted. If the head-mounted device 104 does not receive an acceptance of the selection, such as clicking or head movement, then the head-mounted device 104 can determine that the selection was not accepted. If the head-mounted device 104 determines that the selection was not accepted, then the head-mounted device 104 can continue determining whether the dwell condition is satisfied (206) and/or detecting a gaze (204).

If the head-mounted device 104 determines that the head-mounted device 104 did receive a selection from the user 102 and/or an acceptance of the selection, then the head-mounted device 104 can generate a calibration adjustment 130 (216). The calibration adjustment 130 can be a change to the location where the head-mounted device 104 will present and/or display the cursor 122. The change can be a change from where the head-mounted device 104 would determine, in absence of the calibration adjustment 130, that the user 102 is looking and/or is intending to focus. The head-mounted device 104 can generate the calibration adjustment 130 (216) based on the displacement and/or locational difference of the second location 131, where the user 102 selected the computer-generated icon 116, from the first location 129, where the head-mounted device 104 initially placed the cursor 122. The head-mounted device 104 can determine future placements of the cursor 122, such as at the third location 133, based on the determined gaze(s) 121A, 121B and the determined calibration adjustment 130.

In some examples, the head-mounted device 104 can generate the calibration adjustment 130 (216) based on determining that the user's 102 eye(s) 120A, 120B remained fixated and/or gazed at a same location for a predetermined time (such as at least 200 milliseconds, 600 milliseconds, or 1,200 milliseconds or 1.2 seconds), which can be considered a fixated time threshold, and that the user did not activate a selection at (218). In some examples, the head-mounted device 104 can generate the calibration adjustment 130 (216) based on determining that the first location 129 was wrong and/or incorrect. The head-mounted device 104 can determine that the first location 129 was wrong and/or incorrect based, for example, on the user's 102 eye(s) 120A, 120B remaining fixated and/or gazing at a same location for a predetermined time and the user not activating a selection at (218). The fixation of user's 102 eye(s) 120A, 120B without an activation and/or selection indicates that the user 102 is not receiving feedback that corresponds to the intention of the user 102, because persons typically do not fixate their gaze on something without intending to perform some action on the thing to which their gaze is fixated.

Based on determining that the first location 129 was wrong and/or incorrect, and/or determining that the head-mounted device 104 should generate a calibration adjustment 130 (216), the head-mounted device 104 can generate and/or present a correction cursor. The head-mounted device 104 can generate and/or present the cursor during a head-enabled correction mode. The head-mounted device 104 can move the correction cursor in response to movement of the head 103 and/or head-mounted device 104 in a similar manner to movement of the cursor 122 shown and described with respect to FIGS. 1C, 1E, 1F, and 1G.

In some examples, while the correction cursor (which can be represented by the cursor 122) is moving and/or under control of the user 102, the location of the computer-generated icon 116 can be locked and/or fixed with respect to representations of objects within the physical space 100, such as the representation 106A of the table 106 and/or the representation 108A of the flower 108. In some examples, the location of the correction cursor, which can be represented by the cursor 122, can be locked and/or fixed in a location on the display 110, 110A. The fixed location of the correction cursor on the display 110, 110A and the fixed location of the computer-generated icon 116 with respect to representations of objects can cause the correction cursor to move with respect to the cursor 122 when the user 102 moves the head 103 and/or head-mounted device 104. The relative movement of the correction cursor can be in a same direction as the movement of the head 103 and/or head-mounted device 104. Movement and/or rotation of the head-mounted device 104 and/or display 110 can cause the correction cursor to move with respect to the computer-generated icon 116, until the user 102 moves the correction cursor onto and/or on top of the computer-generated icon 116. After detecting the location of the correction cursor on and/or on top of the computer-generated icon 116, the head-mounted device 104 can indicate alignment and/or section of the computer-generated icon 116, such as changing of appearance of the computer-generated icon 116 shown in FIG. 1G.

After receiving the selection (214) and/or generating the calibration adjustment 130 (216), the head-mounted device 104 can process the selection (218). Processing the selection (218) can include performing an action associated with the selected computer-generated icon 116, such as launching an application, displaying search results, displaying information associated with an object in the physical space 100, or presenting a menu with additional icons to select, as non-limiting examples. The head-mounted device 104 can process the selection (218) before, after, or concurrently with generating the calibration adjustment (216).

After processing the selection (218), the head-mounted device 104 can continue displaying the same icon (202) and/or different or additional icons. When displaying the cursor 122, the head-mounted device 104 can determine the location at which to display the cursor 122 based on both the determined gaze(s) 121A, 121B and the generated calibration adjustment 130.

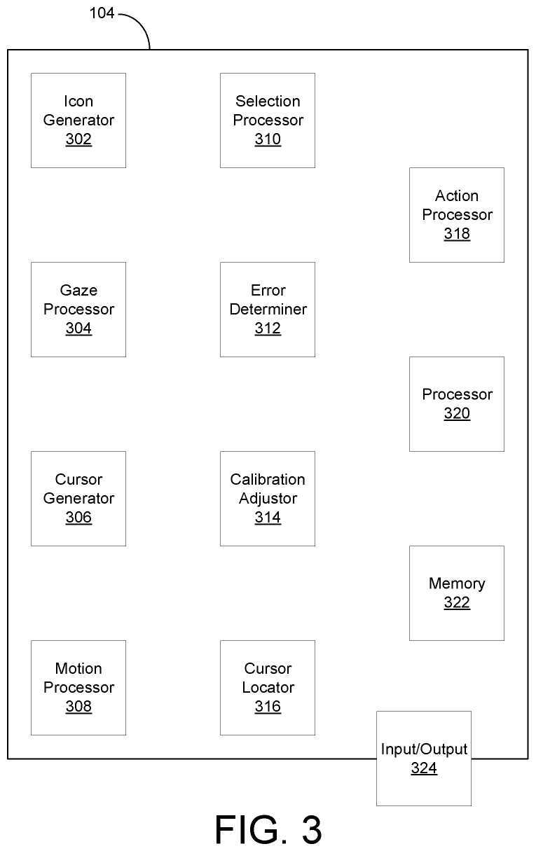

FIG. 3 is a block diagram of the head-mounted device 104. The head-mounted device 104 can include an icon generator 302. The icon generator 302 can generate and/or display computer-generated icons, such as the computer-generated icon 116, 132, on the display 110 of the head-mounted device 104. The generated icons can be associated with physical or virtual objects, such as the flower 108 and/or representation 108A of the flower 108, or can include action buttons such as buttons to perform actions such as launching applications, performing searches, or presenting menus, as non-limiting examples.

The head-mounted device 104 can include a gaze processor 304. The gaze processor 304 can detect and/or process the gaze(s) 121A, 121B of the eye(s) 120A, 120B of the user 102. The gaze processor 304 can detect and/or process the gaze(s) 121A, 121B of the eye(s) 120A, 120B of the user 102 by capturing images of the pupil(s), retina(s), and/or eye(s) 120A, 120B of the user 102 with a gaze-tracking camera(s) 118A, 118B. The gaze processor 304 can determine a direction that the user 102 is looking, and/or a location (such as the first location 129) on the display 110, that the user 102 is intending to look. The gaze processor 304 can determine a direction that the user 102 is looking, and/or a location (such as the first location 129) on the display 110, that the user 102 is intending to look based on determined direction(s) of the gaze(s) 121A, 121B.

The head-mounted device 104 can include a cursor generator 306. The cursor generator 306 can generate, display, and/or present the cursor 122 on the display 110. In some examples, the cursor generator 306 can generate, display, and/or present the cursor 122 in response to the direction of the gaze(s) 121A, 121B of the user 102 being fixed and/or stationary for a predetermined period of time, such as a gaze time threshold that satisfies the dwell condition.

The head-mounted device 104 can include a motion processor 308. The motion processor 308 can process detected and/or measured motion and/or acceleration of the head-mounted device 104. In some examples, the motion processor 308 can process motion detected by an accelerometer included in the head-mounted device 104. The motion processor 308 can determine a direction and/or magnitude of motion and/or acceleration of the head-mounted device 104. The movement and/or acceleration of the head-mounted device 104 can be cause by movement and/or acceleration of the head 103 on which the head-mounted device 104 is mounted.

The head-mounted device 104 can include a selection processor 310. The selection processor 310 can process and/or recognize selections of user interface elements, such as icons 116, 132. The selection processor 310 can process and/or recognize the selections of the user interface elements in response to predetermined input patterns, such as predetermined motions detected by the motion processor 308, predetermined eye movements (or lack of eye movements indicating that the eye(s) 120A, 120B is stationary), contact on the head-mounted device 104, or spoken (auditory) prompts, as non-limiting examples.

The selection processor 310 can prevent inadvertent selections, such as inadvertent selections of the icons 116, 132. In some examples, the selection processor 310 can render the icons 116, 132 unavailable for selection, such as by rendering invisible, hiding, ceasing to display, or ignoring input to or selection of, the icons 116, 132 when the head-mounted device 104 is in motion. In some examples, the selection processor 310 can render the icons 116, 132 unavailable for selection, such as by rendering invisible, hiding, ceasing to display, or ignoring input to or selection of, the icons 116, 132 when the head-mounted device 104 is in motion and the user's 102 gaze(s) 121A, 121B, when corrected for based on the calibration adjustment 130, is not directed at an icon 116, 132. In some examples, the selection processor 310 can render the icons 116, 132 unavailable for selection, such as by rendering invisible, hiding, ceasing to display, or ignoring input to or selection of, the icons 116, 132 when the gaze(s) 121A, 121B indicates that the user 102 is looking a threshold distance beyond the icon 116, 132. In some examples, the icons 116, 132 will be available for selection only when a predefined key on a keyboard in communication with the head-mounted device 104 receives input and/or is depressed or pressed down.

The head-mounted device 104 can include an error determiner 312. The error determiner 312 can determine whether a location of a cursor 122 determined by the head-mounted device 104 is erroneous and/or wrong. The error determiner 312 can determine whether the location of the cursor 122 is erroneous and/or wrong based, for example, on the user 102 moving the head 103 of the user 102 and/or head-mounted device 104, predetermined movements of the eye(s) 120A, 120B indicating that the user 102 is trying to move the cursor 122, or a predetermined oral (auditory) instruction, as non-limiting examples. If the error determiner 312 determines that the location of the cursor 122 is erroneous and/or wrong, the error determiner 312 can prompt a calibration adjuster 314 included in the head-mounted device 104 to change a calibration adjustment and/or move the cursor 122.

In some examples, the error determiner 212 can determine that the location of the cursor 122 is erroneous and/or wrong based on the direction of the movement of the head-mounted device 104 satisfying a similarity condition. The similarity condition can be satisfied if the direction of movement of the head-mounted device 104 is within a direction threshold, such as five degrees, or the direction of the icon 116 from the first location 129.

In some examples, the error determiner 212 can determine that the location of the cursor 122 is erroneous and/or wrong based on the direction of the movement of the head-mounted device 104 and the gaze(s) 121A, 121B satisfying an opposite condition. The opposite condition can be satisfied if directions of movement of the head-mounted device 104 and the gaze(s) 121A, 121B are within an opposite threshold, such as five degrees, of opposite from each other.

The head-mounted device 104 can include a calibration adjuster 314. The calibration adjuster 314 can change, modify, and/or adjust the calibration adjustment 130. The calibration adjuster 314 can change, modify, and/or adjust the calibration adjustment 130 based on a difference and/or displacement between a first location 129 where the head-mounted device 104 initially placed the cursor 122 and a second location 131 where the cursor 122 was placed, and the user 102 made a selection, after the head-mounted device 104 moved the cursor 122 in response to motion detected by the motion processor 308. The head-mounted device 104 can utilize the new and/or modified calibration adjustment 130 for future placements of the cursor 122.

The head-mounted device 104 can include a cursor locator 316. The cursor locator 316 can locate the cursor 122 on the display 110. The cursor locator 316 can locate the cursor 122 on the display 110 based on the determined gaze(s) 121A, 121B and based on the calibration adjustment 130. As the calibration adjuster 314 modifies and/or adjusts the calibration adjustment 130, the cursor locator 316 can become more accurate in placing the cursor 122 where the user 102 desires to place and/or locate the cursor 122.

The head-mounted device 104 can include an action processor 318. The action processor 318 can perform and/or process actions in response to the selection processor 310 determining that the user 102 has made a selection. The action can be associated with a computer-generated icon 116, 132 selected by the user 102. The action can include, for example, launching an application, displaying search results, presenting information associated with an object displayed by the head-mounted device 104, or presenting a menu with additional icons for selection.

The head-mounted device 104 can include at least one processor 320. The at least one processor 320 can execute instructions, such as instructions stored in at least one memory device 322, to cause the head-mounted device 104 to perform any combination of methods, functions, and/or techniques described herein.

The head-mounted device 104 can include at least one memory device 322. The at least one memory device 322 can include a non-transitory computer-readable storage medium. The at least one memory device 322 can store data and instructions thereon that, when executed by at least one processor, such as the processor 320, are configured to cause the head-mounted device 104 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the head-mounted device 104 can be configured to perform, alone, or in combination with the head-mounted device 104, any combination of methods, functions, and/or techniques described herein.

The head-mounted device 104 may include at least one input/output node 324. The at least one input/output node 324 may receive and/or send data, such as from and/or to, a server, and/or may receive input and provide output from and to a user. The input and output functions may be combined into a single node, or may be divided into separate input and output nodes. The input/output node 324 can include, for example, a microphone, a camera (such as the gaze-tracking camera(s) 118A, 118B), an IMU, a display (such as the display 110 and/or displays 110A, 110B), a speaker, a microphone, one or more buttons, and/or one or more wired or wireless interfaces for communicating with other computing devices.

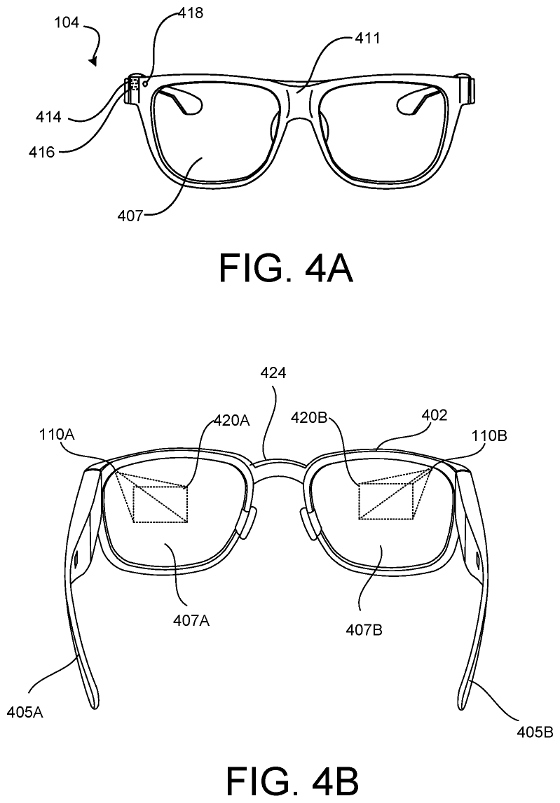

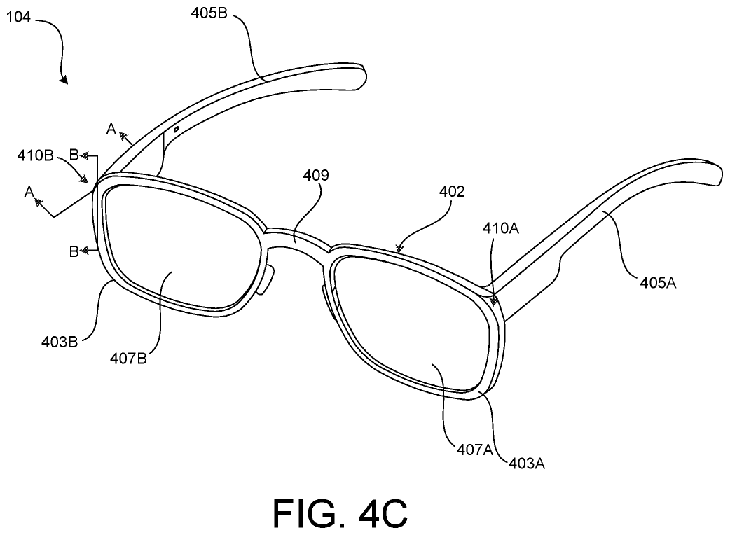

FIGS. 4A, 4B, and 4C show an example of the head-mounted device 104. The head-mounted device 104 can detect a direction of a gaze(s) 121A, 121B of the user 102, detect movement of the head 103 of the user 102, generated and change a location of a cursor 122, present an icon 116, and process a selection by the user 102.

As shown in FIGS. 4A, 4B, and 4C, the example head-mounted device 104 includes a frame 402. The frame 402 includes a front frame portion defined by rim portions 403A, 403B surrounding respective optical portions in the form of lenses 407A, 407B, with a bridge portion 409 connecting the rim portions 403A, 403B. Arm portions 405A, 405B are coupled, for example, pivotably or rotatably coupled, to the front frame by hinge portions 410A, 410B at the respective rim portion 403A, 403B. In some examples, the lenses 407A, 407B may be corrective/prescription lenses. In some examples, the lenses 407A, 407B may be an optical material including glass and/or plastic portions that do not necessarily incorporate corrective/prescription parameters. Displays 110A, 110B (which can be components of the display 110 shown in FIG. 1A) may be coupled in a portion of the frame 402. In the example shown in FIG. 4B, the displays 110A, 110B are coupled in the arm portions 405A, 405B and/or rim portions 403A, 403B of the frame 402. In some examples, the head-mounted device 104 can also include an audio output device 416 (such as, for example, one or more speakers), an illumination device 418, at least one processor 411, and an outward facing image sensor 414 (or camera). In some examples, the head-mounted device 104 may include a see-through near-eye display. For example, the displays 110A, 110B may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 407A, 407B, next to content (for example, digital images, user interface elements, virtual content, and the like) generated by the displays 110A, 110B. In some implementations, waveguide optics may be used to depict content on the displays 110A, 110B via outcoupled light 420A, 420B.

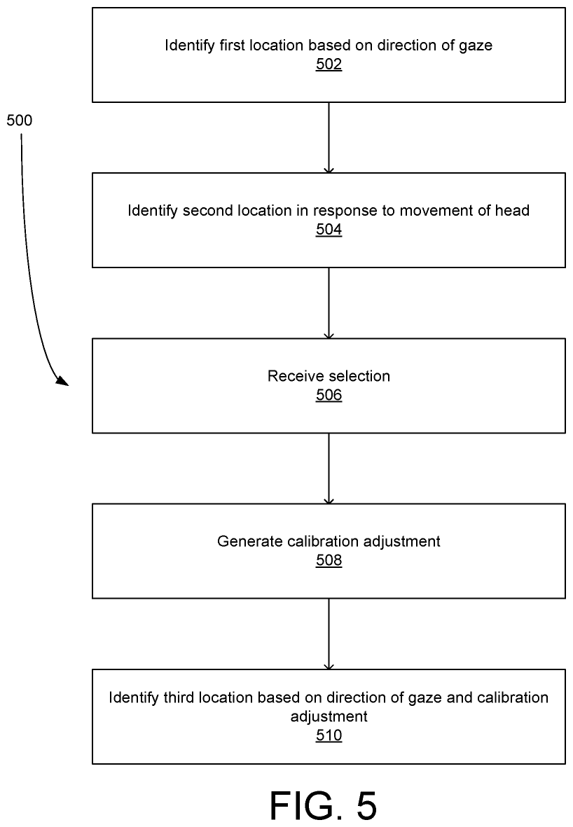

FIG. 5 is a flowchart showing a method 500 performed by the head-mounted device 104 according to an example. The method 500 can include identifying a first location based on a first direction of a gaze of at least one eye of a user, the head-mounted computing device being mounted on a head of the user (502). The method 500 can include identifying a second location in response to a movement of the head of the user (504). The method 500 can include receiving, from the user, a selection associated with the second location (506). The method 500 can include generating a calibration adjustment based on the first direction, the second location, and the selection (508). The method can include identifying a third location based on a second direction of the gaze of the at least one eye of the user and the calibration adjustment (510).

In some examples, the generation of the calibration adjustment is based on the first direction, the second location, the selection, and the movement of the head of the user.

In some examples, the second location includes a computer-generated virtual element.

In some examples, the method 500 further includes, in response to receiving the selection, performing a predetermined action, the predetermined action being associated with the computer-generated virtual element.

In some examples, a location of the computer-generated virtual element remains fixed with respect to objects in physical space outside the head-mounted device.

In some examples, the identifying the second location in response to the movement of the head of the user includes moving a cursor from the first location to the second location, and the method further comprises changing an appearance of the computer-generated virtual element in response to a distance of the cursor from the computer-generated virtual element satisfying a distance threshold.

In some examples, the identifying the second location includes moving an identified location in an adjustment direction from the first location to the second location, the adjustment direction being based on a direction of movement of the head of the user.

In some examples, the identifying the first location includes displaying a cursor at the first location, the identifying the second location includes moving the cursor from the first location to the second location, and a location of the cursor is fixed on a display included in the head-mounted device while the head-mounted device moves.

In some examples, the movement of the head of the user is a first movement of the head of the user, and the selection associated with the second location includes a second movement of the head of the user.

In some examples, the identifying the first location is performed in response to determining that a duration of the gaze in the first direction satisfies a gaze time threshold.

In some examples, the generation of the calibration adjustment includes generating a calibration adjustment based on the first direction, the movement, the second location, and the selection.

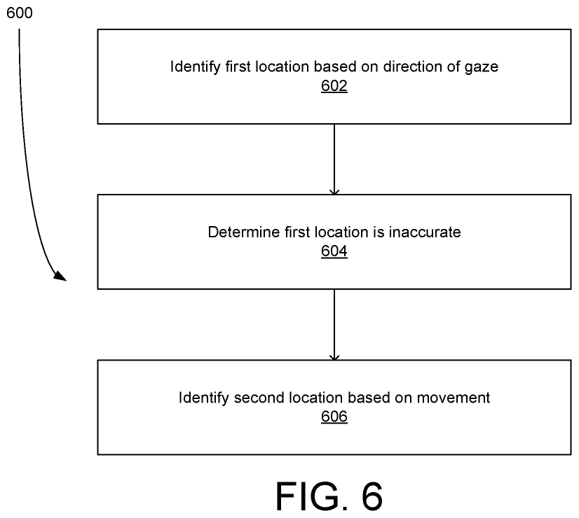

FIG. 6 is a flowchart showing a method 600 performed by the head-mounted device 104 according to an example. The method 600 can include. identifying a first location on a display based on a direction of a gaze of a user wearing the head-mounted device, the display being included in the head-mounted device (602). The method 600 can include determining, based on the direction of the gaze of the user remaining fixed for a predetermined period of time, that the first location was inaccurate (604). The method 600 can include identifying a second location on the display based on the direction of the gaze and movement of the head-mounted device (606).

In some examples, the determination that the first location was inaccurate is based on the direction of the gaze of the user remaining fixed for the predetermined period of time and a direction of the movement of the head-mounted device satisfying a direction similarity condition for a direction of a computer-generated icon from the first location.

In some examples, the determination that the first location was inaccurate is based on the direction of the gaze of the user remaining fixed for the predetermined period of time and the head-mounted device moving in a first direction while the gaze of the user moves in a second direction, the second direction satisfying an opposite direction condition.

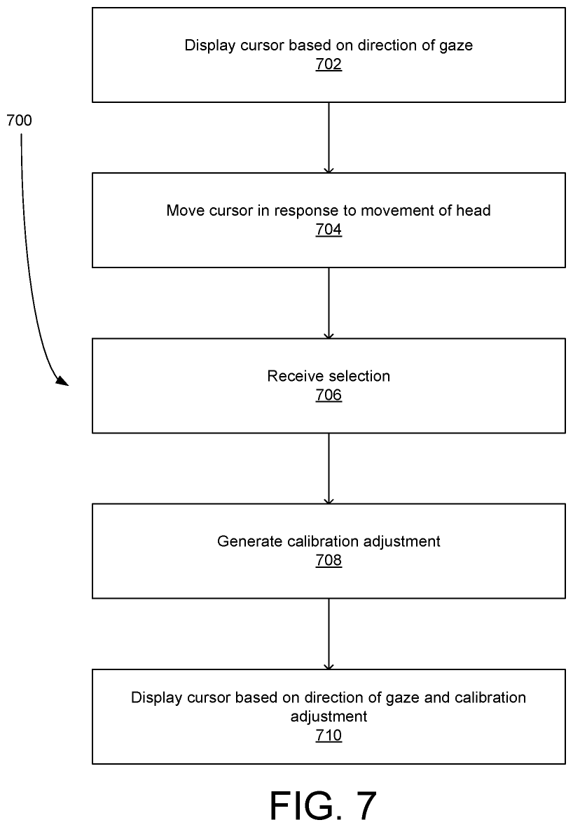

FIG. 7 is a flowchart showing a method 700 performed by the head-mounted device 104 according to an example. The method 700 can include displaying a cursor at a first location, the first location of the cursor being based on a first direction of a gaze of at least one eye of a user, the head-mounted computing device being mounted on a head of the user (702). The method 700 can include moving the cursor to a second location in response to a movement of the head of the user (704). The method 700 can include receiving, from the user, a selection associated with the second location (706). The method 700 can include generating a calibration adjustment based on the first direction, the second location, and the selection (708). The method 700 can include displaying the cursor at a third location, the third location of the cursor being based on a second direction of the gaze of the at least one eye of the user and the calibration adjustment (710).

In some examples, the movement of the cursor to the second location includes moving the cursor in an adjustment direction, the adjustment direction being based on a direction of movement of the head of the user.

In some examples, the cursor is displayed on a lens included in the head-mounted computing device, at least a portion of the lens being transparent.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A method performed by a head-mounted computing device, the method comprising:
identifying a first location based on a first direction of a gaze of at least one eye of a user, the head-mounted computing device being mounted on a head of the user;
identifying a second location in response to a movement of the head of the user;
receiving, from the user, a selection associated with the second location;
generating a calibration adjustment based on the first direction, the second location, and the selection; and
identifying a third location based on:
a second direction of the gaze of the at least one eye of the user; and
the calibration adjustment.

2. The method of claim 1, wherein the generation of the calibration adjustment is based on the first direction, the second location, the selection, and the movement of the head of the user.

3. The method of either of claim 1, wherein the second location includes a computer-generated virtual element.

4. The method of claim 2, further comprising, in response to receiving the selection, performing a predetermined action, the predetermined action being associated with the computer-generated virtual element.

5. The method of claim 2, wherein a location of the computer-generated virtual element remains fixed with respect to objects in physical space outside the head-mounted device.

6. The method of claim 2, wherein:
the identifying the second location in response to the movement of the head of the user includes moving a cursor from the first location to the second location; and
the method further comprises changing an appearance of the computer-generated virtual element in response to a distance of the cursor from the computer-generated virtual element satisfying a distance threshold.

7. The method of claim 1, wherein the identifying the second location includes moving an identified location in an adjustment direction from the first location to the second location, the adjustment direction being based on a direction of movement of the head of the user.

8. The method of claim 1, wherein:
the identifying the first location includes displaying a cursor at the first location;
the identifying the second location includes moving the cursor from the first location to the second location; and
a location of the cursor is fixed on a display included in the head-mounted device while the head-mounted device moves.

9. The method of claim 1, wherein:
the movement of the head of the user is a first movement of the head of the user; and
the selection associated with the second location includes a second movement of the head of the user.

10. The method of claim 1, wherein the identifying the first location is performed in response to determining that a duration of the gaze in the first direction satisfies a gaze time threshold.

11. The method of claim 1, wherein the generation of the calibration adjustment includes generating a calibration adjustment based on the first direction, the movement, the second location, and the selection.

12. A non-transitory computer-readable storage medium comprising instructions stored thereon that, when executed by at least one processor, are configured to cause a head-mounted computing device to perform the method of claim 1.

13. A computing device configured to mount onto a head of a user, the computing device comprising:
a display;
a gaze-tracking camera;
at least one processor; and
a non-transitory computer-readable storage medium comprising instructions stored thereon that, when executed by the at least one processor, are configured to cause the computing device to perform the method of claim 1.

14. A method performed by a head-mounted device, the method comprising:
identifying a first location on a display based on a direction of a gaze of a user wearing the head-mounted device, the display being included in the head-mounted device;
determining, based on the direction of the gaze of the user remaining fixed for a predetermined period of time, that the first location was inaccurate; and
identifying a second location on the display based on the direction of the gaze and movement of the head-mounted device.

15. The method of claim 14, wherein the determination that the first location was inaccurate is based on the direction of the gaze of the user remaining fixed for the predetermined period of time and a direction of the movement of the head-mounted device satisfying a direction similarity condition for a direction of a computer-generated icon from the first location.

16. The method of claim 14, wherein the determination that the first location was inaccurate is based on the direction of the gaze of the user remaining fixed for the predetermined period of time and the head-mounted device moving in a first direction while the gaze of the user moves in a second direction, the second direction satisfying an opposite direction condition.

17. A non-transitory computer-readable storage medium comprising instructions stored thereon that, when executed by at least one processor, are configured to cause a head-mounted computing device to perform the method of claim 14.

18. A computing device configured to mount onto a head of a user, the computing device comprising:
a display;
a gaze-tracking camera;
at least one processor; and
a non-transitory computer-readable storage medium comprising instructions stored thereon that, when executed by the at least one processor, are configured to cause the computing device to perform the method of claim 14.

19. A method performed by a head-mounted computing device, the method comprising:
displaying a cursor at a first location, the first location of the cursor being based on a first direction of a gaze of at least one eye of a user, the head-mounted computing device being mounted on a head of the user;
moving the cursor to a second location in response to a movement of the head of the user;
receiving, from the user, a selection associated with the second location;
generating a calibration adjustment based on the first direction, the second location, and the selection; and
displaying the cursor at a third location, the third location of the cursor being based on:
a second direction of the gaze of the at least one eye of the user; and
the calibration adjustment.

20. The method of claim 19, wherein the movement of the cursor to the second location includes moving the cursor in an adjustment direction, the adjustment direction being based on a direction of movement of the head of the user.

21. The method of claim 19, wherein the cursor is displayed on a lens included in the head-mounted computing device, at least a portion of the lens being transparent.

22. A non-transitory computer-readable storage medium comprising instructions stored thereon that, when executed by at least one processor, are configured to cause a head-mounted computing device to perform the method claim 19.

23. A computing device configured to mount onto a head of a user, the computing device comprising:
a display;
a gaze-tracking camera;
at least one processor; and
a non-transitory computer-readable storage medium comprising instructions stored thereon that, when executed by the at least one processor, are configured to cause the computing device to perform the method of claim 19.
